(19) United States
(12) Patent Application Publication
(10) Pub. No.: US 2017/0006850 A1
(43) Pub. Date: Jan. 12, 2017

(54) APPARATUS FOR TRAPPING INSECTS

(71) Applicant: Combined Distributors, Inc., Toms River, NJ (US)

(72) Inventor: Morris DOMAN, Toms River, NJ (US)

(21) Appl. No.: 14/794,649

(22) Filed: Jul. 8, 2015

(51) Int. Cl. A01M 1/10; A01M 1/02; A01M 1/12

(52) U.S. Cl. CPC A01M 1/106; A01M 1/12; A01M 1/02

(57) ABSTRACT

An apparatus for trapping insects having a trap body comprising at least one top channel having at least two opposed openings, the at least one top channel forming a top flow path through which air may freely flow, and a bottom channel arranged transverse to the top channel and having a first opening in fluid communication with the top flow path and a second opening opposing the first opening, said bottom channel forming a bottom flow path through which air may freely flow, wherein the trap body is configured to be operatively connected to at least one container, the at least one container configured to hold a bait for insects, and having at least one container opening configured to engage with the bottom channel such that the at least one container is in fluid communication with the top and bottom flow paths.

### FIELD OF THE INVENTION

The present invention relates generally to the field of insect traps, and more particularly to a system and apparatus for trapping insects, in particular flies.

### BACKGROUND OF THE INVENTION

The prolific population of undesirable insects and other similar pests is a significant problem in most areas of the world. Insects such as mosquitoes and flies carry diseases that may be spread to humans with devastating effects. The ability to effectively capture undesirable insects and similar subjects may be a significant advantage in fighting the spread of disease. In regions where diseases such as malaria or West Nile virus are rampant, this ability would vastly facilitate efforts in promoting health. In regions where such diseases are not as common, this ability would prevent attacks on humans and other animals by such insects.

In addition, traps may be desirable for ridding gardens, picnic areas, barbeques, pools, playgrounds and other premises of insects, especially biting and stinging insects.

Currently available insect traps typically involve numerous parts and are costly to manufacture. In addition, most traps are single-use traps that must be discarded, which creates unnecessary waste and may be expensive for the end-user. Moreover, currently available traps are not able to efficiently attract, trap and kill an adequate number of insects and similar subjects, thus resulting in scenarios that necessitate additional traps or have inadequate protection against insects and similar subjects. Much of this inadequacy originates from an ineffective distribution of the bait scent, which inhibits the insect from finding the trap.

For example, U.S. Design Patent No. D478,647, issued Aug. 19, 2003 and entitled “BOTTLE INSECT CATCHER”, depicts an ornamental design for an insect trap having a top trap portion and a funnel portion extending into a bottle. The top trap portion includes an enclosure having several holes that allow insects to access the enclosure as well as presumably allow the scent of the bait to escape and permeate the surrounding environment. However, among other deficiencies, the holes of the enclosure are not aligned with each other, which inhibit the free flow of air through the enclosure. This, in turn, inhibits the distribution of the scent of the bait into the environment and reduces the effectiveness of the trap.

Thus, there is a need for an improved trap for insects and similar pests that facilitates wide-spread distribution of the bait scent thereby increasing the effectiveness of the trap.

### SUMMARY OF THE INVENTION

Accordingly, it is an object of the present invention to provide an improved apparatus for trapping insects, especially flies. The improved apparatus may be modular and re-usable, and may be especially configured to increase the distribution of the scent of the bait with “jet-stream technology”, which is a phrase used to describe the increased air flow through portions of the trap effected by the structure and configuration of the trap body.

Specifically, in certain embodiments, it is another object of the present invention to provide a trap body (e.g., a hollow trap body) including at least one top channel having at least two diametrically or substantially opposed openings, the at least one top channel forming a top flow path through which air may freely flow. In other embodiments, the at least two openings may not oppose each other. In preferred embodiments, the openings are sufficiently large to allow an insect to enter the top channel.

In some embodiments, the top channel's at least two openings are vertically arranged transverse to a longitudinal axis of the at least one top channel, although it is contemplated that the at least two openings have other configurations such as, for example, a tapered configuration or an angled configuration. In certain embodiments, a bottom portion of the openings may include a platform adapted to allow flying insects to land prior to entering the top channel.

In certain embodiments the trap body may also include a bottom channel having a first opening in fluid communication with the top flow path and a second opening diametrically or substantially opposing the first opening, the bottom channel forming a bottom flow path through which air may freely flow. In preferred embodiments, the first and second openings are sufficiently large to allow an insect to enter the bottom channel.

In preferred embodiments, a longitudinal axis of the at least one top channel is arranged transverse to a longitudinal axis of the bottom channel. That is, the bottom channel extends in a direction that is approximately perpendicular to a direction in which the tap channel extends.

In certain embodiments, the apparatus of the present invention may include a funnel portion having an elongated shaft separating an open proximal end and an open distal end, the open proximal end configured to releasably fit within or otherwise be operatively connected or fastened to the bottom channel such that the funnel portion is in fluid communication with the top and bottom flow paths. That is, it is contemplated that the funnel portion is a separate component from the trap body, in which a proximal end of the funnel portion may be inserted into the trap body through the trap body's bottom channel, or be otherwise connected or fastened to the trap body's bottom channel, while the distal end, as well as the majority of the elongated shaft, extend out from the bottom channel.

As mentioned above, in some embodiments the funnel portion's proximal and distal ends are open. In this way, a flow path may be created between the open distal end through to the open proximal end and into the flow paths formed by the trap body's top and bottom channels. In preferred embodiments, the openings at the distal and proximal ends of the funnel portion are sufficiently large to allow an insect to enter the funnel portion.

In preferred embodiments, the funnel portion's elongated shaft includes a plurality of apertures or vents. In some embodiments, the apertures may be large enough for insects to pass through, but it is contemplated that this is not the aperture's primary purpose, which is to facilitate the flow of air (and, therefore, the bait scent) through the funnel portion. In some embodiments, the plurality of apertures may be provided in place of an opening at the distal end. In such embodiments, the plurality of apertures functions as openings for both insects to pass through and for the scent of the bait to flow through.

In some embodiments of the present invention, the funnel portion's distal end may be tapered in a direction extending from the elongated shaft to the opening at the funnel portion's distal end. That is, in this embodiment, the diameter of the distal end at the opening is narrower than the diameter of the elongated shaft at, for example, the apertures.

In some embodiments, the funnel portion may be formed in two parts or two halves. For example, in some embodiments, the funnel portion may be split, e.g., in half lengthwise such as, for example, along a longitudinal axis. In some embodiments, the funnel portion's two halves may be joined together by at least one hinge such as, for example, a living hinge. Thus, the funnel portion may have an open configuration and a closed configuration. In some embodiments, the funnel portion may include one hinge, while in other embodiments the funnel portion may include two or more (e.g., a plurality) of hinges. In other embodiments, it is contemplated that the funnel portion is not formed in two pieces, but is instead formed as one integral piece.

In the embodiments where the funnel portion has one hinge (e.g., a living hinge), the hinge may extend along a small portion (e.g., between 15% and 50%) of the funnel portion's longitudinal axis. In this embodiment, the hinge may be located at an approximate middle section of the funnel portion, although other locations are contemplated. For example, the funnel portion may have a top section (e.g., including the proximal end), a middle section, and a bottom section (e.g., including the distal end), and the hinge may be located in any one of these sections such as, for example, the middle section.

In other embodiments, the hinge may extend along a large portion (e.g., between 51% and 95%) of the funnel portion's longitudinal axis. That is, the hinge may extend substantially the entire length of the funnel portion, such as, for example, from the proximal end to the top of the tapered part at the distal end. For example, the hinge may extend from the top section, through the middle section, and into at least a portion of the bottom section (e.g., stopping at the tapered part). Or, in another example, the hinge may extend from at least a portion of the top section, through the middle section, and into at least a portion of the bottom section. Other arrangements are possible.

In some embodiments, it is contemplated that the funnel portion may not be necessary and may not be used in connection with the apparatus for trapping insects.

In addition, certain embodiments of the present invention may include at least one container configured to hold bait for insects and/or the insects. In preferred embodiments, the at least one container has at least one container opening configured to accept the funnel portion therethrough and is further configured to engage (e.g., connect) with the bottom channel such that the at least one container is in fluid communication with the top and bottom flow paths. That is, the funnel portion's distal end, as well as the portion of the elongated shaft extending from the bottom channel of the trap body, is inserted into the container through the container opening. In some embodiments, the diameter of the bottom channel is large enough to accommodate the funnel portion's proximal end as well as the container's opening. In this way, the top channel, the bottom channel and the funnel portion establish a continuous flow path between the internal contents of the at least one container and the outside environment. In some embodiments, the diameter of the bottom channel may be sized to match the size of the container's opening such that the bottom channel and the container's opening may be functionally and/or fluidly connected, for example, by use of a fastening means. In accordance with the various embodiments, the continuous flow path ensures that the scent of the bait contained within the container is sufficiently dispersed throughout the surrounding environment.

In some embodiments, the at least one container may be a bag or a bottle. For example, in some embodiments, the container may be a plastic bag while in other embodiments the container may be a plastic bottle (e.g., a plastic soda bottle). Containers made of materials other than plastic, (e.g., paper, metal, rubber or glass) are also contemplated. In embodiments where the container is a plastic bag, the bag may include a weldspout configured to connect with the bottom channel of the trap body, and further configured to accept the funnel portion inserted therein. In embodiments where the container is a bottle, the bottle may include a screw top configured to connect with the bottom channel of the trap body, and may further be configured to accept the funnel portion inserted therein.

In some embodiments, the funnel portion may include a lip that surrounds an edge (e.g., an external edge) of the funnel portion's open proximal end. The lip serves as a stop that prevents the funnel portion from falling into the container. In some embodiments, the lip extends away from the edge of the funnel portion only to the extent necessary to prevent the funnel portion from falling into the container. In some embodiments, it is contemplated that the lip aligns with a top surface of the container opening (e.g., the lip does not extend out further than an outer surface of the container opening). In this way, the lip prevents the funnel portion from falling into the container, but does not prevent the bottom channel from engaging and connecting with the container opening.

In some embodiments, the bottom channel's second opening includes internal threading configured to engage with external threading on the at least one container opening. For example, in some embodiments, the internal threading of the bottom channel may engage with threading located on the weldspout of a plastic bag, while in other embodiments the internal threading may engage with threading located on the screw top of a plastic bottle (e.g., a soda bottle).

In another embodiment, the second opening of the bottom channel may not include threading, but may instead be configured to snap onto, or otherwise be fastened to, the at least one container opening.

In certain embodiments, the trap body may include at least two top channels, each top channel having at least two diametrically or substantially opposed openings. In this embodiment, it is contemplated that there may be at least four openings, in which a first top channel includes a first opening diametrically or substantially opposing a second opening, and a second top channel includes a third opening diametrically opposing a fourth opening. In other embodiments, the first and second openings and the third and fourth openings may not oppose each other.

In some embodiments, the trap body may include more than two top channels. For example, trap body may include three top channels, four top channels, five top channels, etc. In these embodiments, each top channel has at least one opening sufficiently large to allow an insect to enter the top channel. For example, in some embodiments, trap body may include three top channels having at least one opening apiece, in which each top channel may be connected at one end to a bottom channel. In this embodiment, the top channels may be arranged or spaced radially around the bottom channel, such as, for example, arranged radially relative to a longitudinal axis of the bottom channel. In another embodiment, two top channels may be arranged on a single longitudinal axis such that openings substantially oppose each other, while the third top channel is arranged substantially perpendicular to the other two top channels. Other configurations are also contemplated.

In certain embodiments, a first top channel (or a longitudinal axis thereof) of the at least two top channels is arranged transverse to a second top channel (or a longitudinal axis thereof), thereby forming a first top flow path that, in some embodiments, intersects a second top flow path. For example, the structures of the first and second top channels may form a cross (‘+’) shape. In another embodiment, the trap body may include only one top channel, which, together with the bottom channel, may form, for example, a ‘T’ shape. In preferred embodiments, the trap body may be hollow, which allows air to freely flow between the one or more (e.g., two or more) top channels and the bottom channel.

In some embodiments, multiple top channels may be provided which do not cross each other but instead each individually forms a ‘T’ shape with the bottom channel. In some embodiments, a top channel may be configured to be pivoted or otherwise be angled with respect to a bottom channel such that the top channel and bottom channel are not perpendicular to each other. Such embodiments may enable maximizing air flow through the top channel by being directionally adjusted to conform to a particular wind flow direction at the location of the trap.

In yet another embodiment of the present invention the at least one container configured to hold the bait may be situated or arranged within a second container, in which the second container has a plurality of holes. For example, in one embodiment, the container is a bag that is placed into a cup that has a plurality of holes. Light enters the cup through the holes, thus keeping the insects contained within the bag moving horizontally (e.g., towards the holes and the light) rather than vertically (e.g., towards an exit from the trap).

### BRIEF DESCRIPTION OF THE DRAWINGS

The subject matter regarded as the invention is particularly pointed out and distinctly claimed in the concluding portion of this specification. The invention, however, both as to organization and method of operation, together with objects, features, and advantages thereof, may best be understood by reference to the following detailed descriptions when read with the accompanying drawings in which:

FIG. 1A is an illustration of an exploded view of a trap body according to aspects of certain embodiments of the present invention;

FIG. 1B is an illustration of a perspective view of a trap body according to aspects of certain embodiments of the present invention;

FIG. 1C is an illustration of a perspective view of a trap body showing the flow paths according to aspects of certain embodiments of the present invention;

FIG. 2A is an illustration of a side view of the trap body according to aspects of certain embodiments of the present invention;

FIG. 2B is an illustration of a side view through section A-A of the trap body illustrated in FIG. 2A according to aspects of certain embodiments of the present invention;

FIG. 2C is an illustration of a top view through section B-B of the trap body illustrated in FIG. 2A according to aspects of certain embodiments of the present invention;

FIG. 2D is an illustration of a side view through section F-F of the trap body illustrated in FIG. 2A according to aspects of certain embodiments of the present invention;

FIG. 2E is an illustration of a cross-sectional view through section G-G of the trap body illustrated in FIG. 2A according to aspects of certain embodiments of the present invention;

FIG. 3 is an illustration of a side view of a funnel portion according to aspects of certain embodiments of the present invention;

FIG. 4 is an illustration of a cross-sectional view of a two-piece funnel portion according to aspects of certain embodiments of the present invention;

FIG. 5A is an illustration of a perspective view of a trap body attached to a weldspout according to aspects of certain embodiments of the present invention;

FIG. 5B is an illustration of a side view of the trap body and weldspout as shown in FIG. 5A according to aspects of certain embodiments of the present invention;

FIG. 5C is an illustration of a cross-section view through section A-A of the trap body and weldspout shown in FIG. 5B according to aspects of certain embodiments of the present invention;

FIG. 5D is an illustration of a magnified view of the connection between the trap body and the weldspout according to aspects of certain embodiments of the present invention; and

FIGS. 6A and B are illustrations of different perspectives of a trap body and funnel portion attached to a container according to aspects of certain embodiments of the present invention.

It will be appreciated that, for simplicity and clarity of illustration, elements shown in the figures have not necessarily been drawn to scale. For example, the dimensions of some of the elements may be exaggerated relative to other elements for clarity. Additionally, the many features of any one embodiment shown in a figure should not be considered independent and separate from the features of an embodiment shown in another figure, and it is conceivable that features of any one embodiment may be combinable with another. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, and/or components have not been described in detail so as not to obscure the present invention.

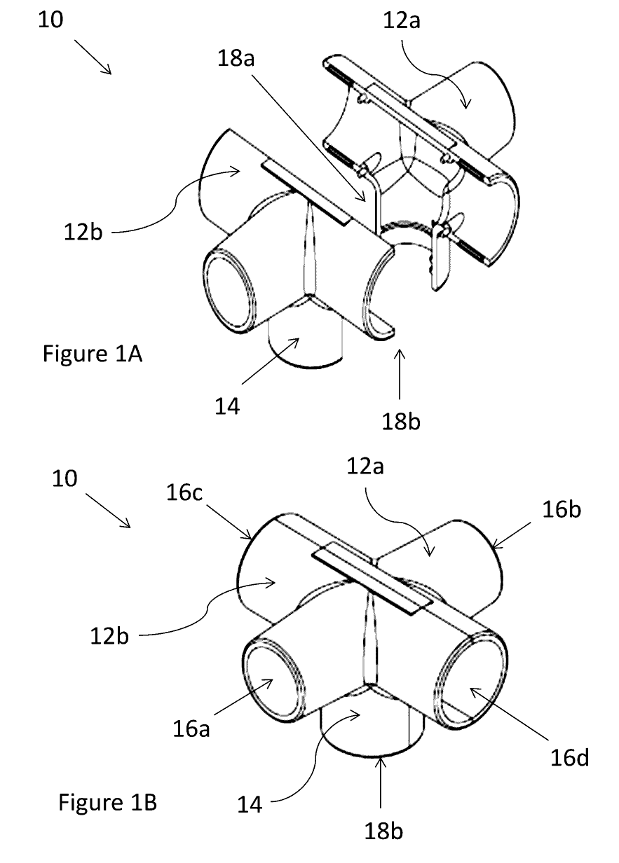

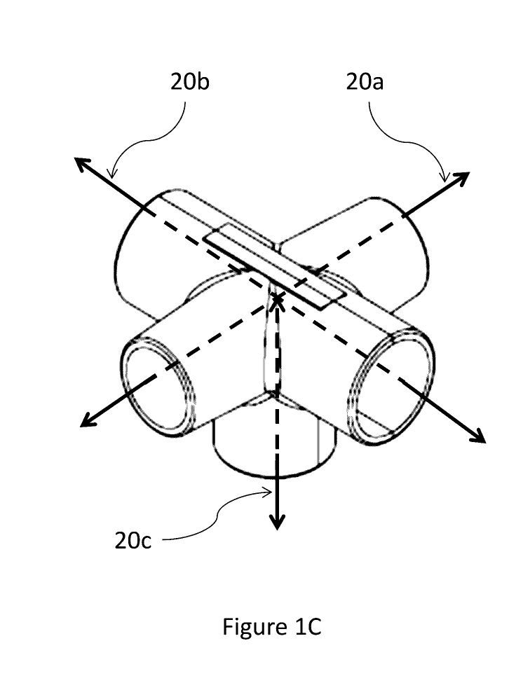

Reference is now made to FIG. 1A, which is an illustration of an exploded view of a trap body 10 according to aspects of certain embodiments of the present invention. Reference is also made to FIG. 1B, which is an illustration of a perspective view of a trap body 10 according to aspects of certain embodiments of the present invention. As illustrated in FIG. 1A, trap body 10 may be formed in two pieces that snap together to form a single piece. However, it is contemplated that trap body 10 may initially be made as one piece or as multiple pieces. In preferred embodiments, trap body 10 has a hollow interior such as illustrated in, for example, FIG. 1A, which facilitates the flow of air through trap body 10.

Trap body 10 may include at least one but preferably two or more (e.g., a plurality) top channels 12. In the embodiment illustrated in FIGS. 1A and 1B, trap body 10 includes a first top channel 12a and a second top channel 12b, as well as bottom channel 14. In preferred embodiments, a longitudinal axis of at least one, and, preferably, at least two, top channel(s) 12 is arranged transverse to a longitudinal axis of the bottom channel 14. Thus, in embodiments where a first top channel 12a of the at least two top channels 12 is arranged transverse to a second top channel 12b (such as shown in, e.g., FIGS. 1A-C), the flow paths 20 intersect, thereby forming a cross (‘+’) shape. In other embodiments, trap body 10 may include only one top channel 12, which, together with the bottom channel 14, forms a ‘T’ shape. Of course, more or less channels may also be provided. For example, trap body 10 may include three top channels arranged radially relative to a longitudinal axis of the bottom channel 14 so as to form, for example, a ‘Y’ shape.

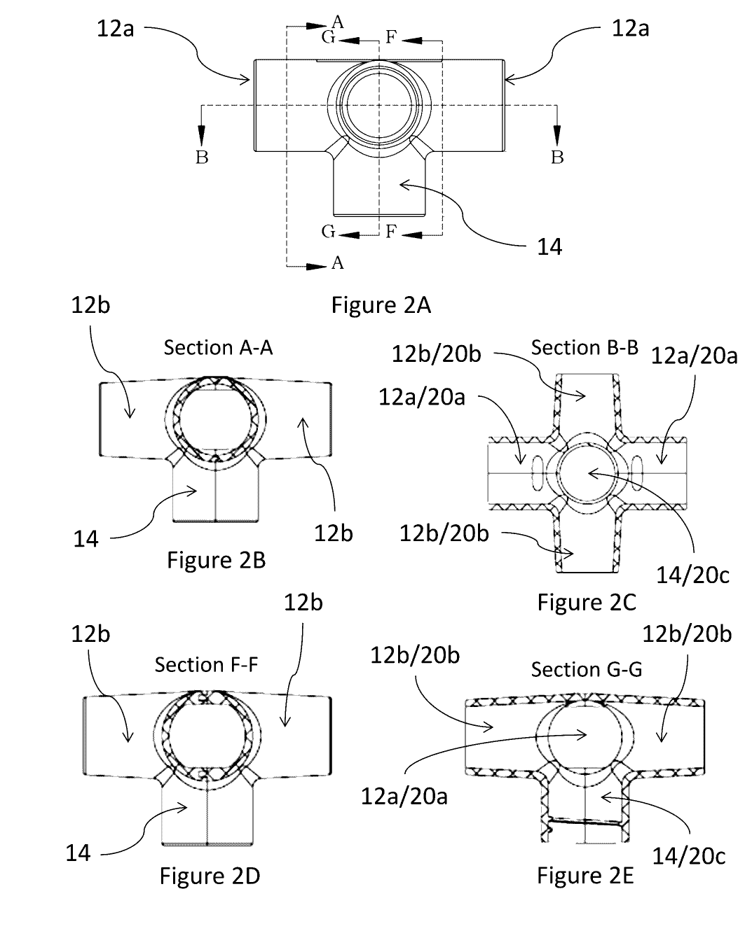

FIGS. 2A-2E illustrate several views of trap body 10 having a “+” shape by showing trap body 10 through multiple sections A-A, B-B, F-F and G-G according to aspects of certain embodiments of the present invention. FIGS. 2B and 2D illustrate opposing views of trap body 10 from a point of view looking through flow channel 20a formed by top channel 12a. As can be seen in FIGS. 2B and 2D, a longitudinal axis of top channel 12b is arranged transverse to a longitudinal axis of top channel 12a (thereby forming a “+” shape) and is also arranged transverse to a longitudinal axis of bottom channel 14. FIGS. 2C and 2E are cross-sectional views of trap body 10 through sections B-B and G-G, respectively. FIG. 2C depicts a top cross-sectional view of trap body 10 and illustrates flow paths 20a, 20b and 20c formed by top channel 12a, top channel 12b and bottom channel 14, respectively, and also illustrates how each flow path may be in fluid communication with the other flow paths. FIG. 2E depicts a side cross-sectional view of trap body 10 and illustrates flow paths 20a, 20b and 20c formed by top channel 12a, top channel 12b and bottom channel 14, respectively, from the point of view looking through flow path 20a formed by top channel 12a.

It should be noted that, while embodiments depicted in FIGS. 1A-2E show two top channels which are perpendicularly transverse to one another (e.g., at right angles), in other embodiments multiple channels may traverse one another such that the channels are not perpendicular to one another (e.g., forming acute and obtuse angles to one another, as in an ‘X’ or a ‘*’ or a ‘Y’ shape, for example).

As illustrated in FIG. 1B, in some embodiments of the present invention, each of the at least two top channels 12a and 12b includes at least two diametrically or substantially opposed openings 16. For example, in certain embodiments, first top channel 12a includes opening 16a diametrically or substantially opposing opening 16b and second top channel 12b includes opening 16c diametrically or substantially opposing opening 16d. As used herein, the phrase diametrically opposing refers to openings that are completely opposed, while the phrase substantially opposed refers to openings that are not completely opposed and includes openings (and respective top channels) that are arranged at angles to each other. In preferred embodiments, the openings are sufficiently large to allow an insect to enter the trap body 10 and traverse one or more top channel(s) 12.

The diametrically or substantially opposed openings provide one or more straight or substantially straight flow path(s) 20 through top channel(s) 12. This arrangement allows for cross-ventilation between two or more openings, thereby increasing the speed and quantity of the air that flows through flow path(s) 20 formed by top channels 12 (e.g., the “jet-stream technology” mentioned above). The cross-ventilation between the two or more openings 16 also increases the distribution of the bait scent by mixing the scent with the air flowing through the top channel(s) 12. Due to the cross-ventilation arrangement of trap body 10, a greater amount of air may flow through the top channel with higher speed, which may distribute the scent more effectively, thereby potentially attracting a greater amount of insects. FIG. 1C is an illustration of a perspective view of a trap body 10 showing the flow paths 20a, 20b and 20c created, for example, by top channel 12a, top channel 12b and bottom channel 14, respectively, according to aspects of various embodiments of the present invention.

In some embodiments, the at least two diametrically opposed openings 16 of the top channel are vertically arranged transverse to a longitudinal axis of the top channel(s) 12, although it is contemplated that the at least two openings 16 may have other configurations such as, for example, a tapered configuration or an angled configuration. In some embodiments, a bottom portion of the openings 16 may include a platform (not shown) adapted to allow flying insects to land prior to entering top channel 12 through opening 16.

In certain embodiments, the trap body 10 may also include a bottom channel 14 having an axis arranged transverse to an axis of top channel 12 and having a first opening 18a (FIG. 1A) in fluid communication with a top flow path 20 formed by top channel 12, and a second opening 18b (FIGS. 1A and 1B) diametrically or substantially opposing the first opening 18a. As used herein, the term “fluid communication” may indicate that air may freely flow between bottom channel 14 and one or more top channel(s) 12. In some embodiments, bottom channel 14 forms a bottom flow path 20c (FIG. 1C) through which air may freely flow. In preferred embodiments, the first and second openings 18a,b are sufficiently large to allow an insect to enter the bottom channel. In some embodiments, a longitudinal axis of bottom channel 14 is arranged transverse (e.g., orthogonal) to a longitudinal axis of one or more top channel(s) 12.

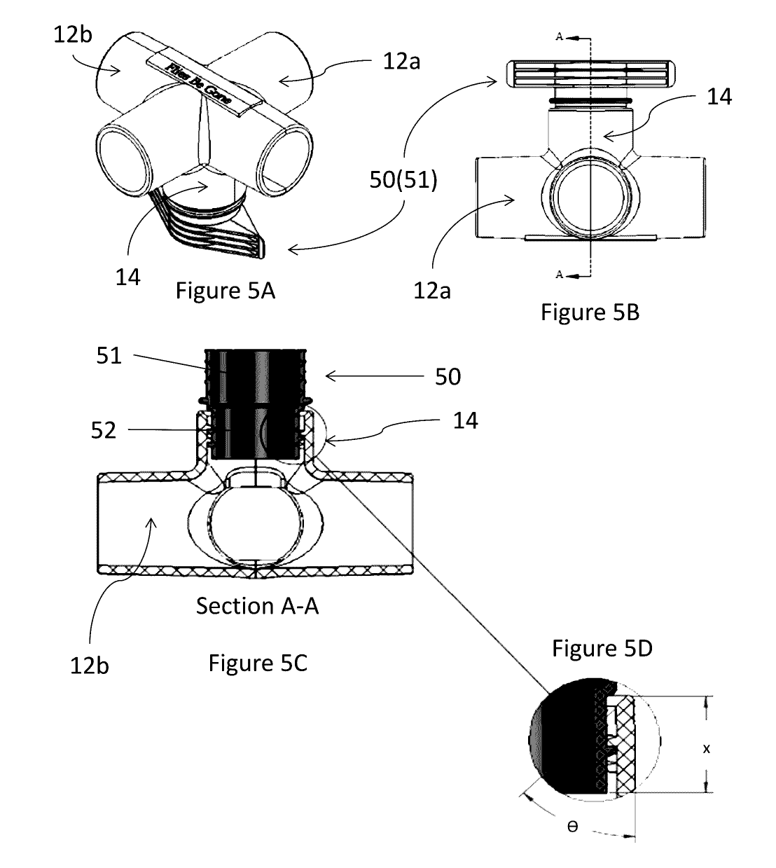

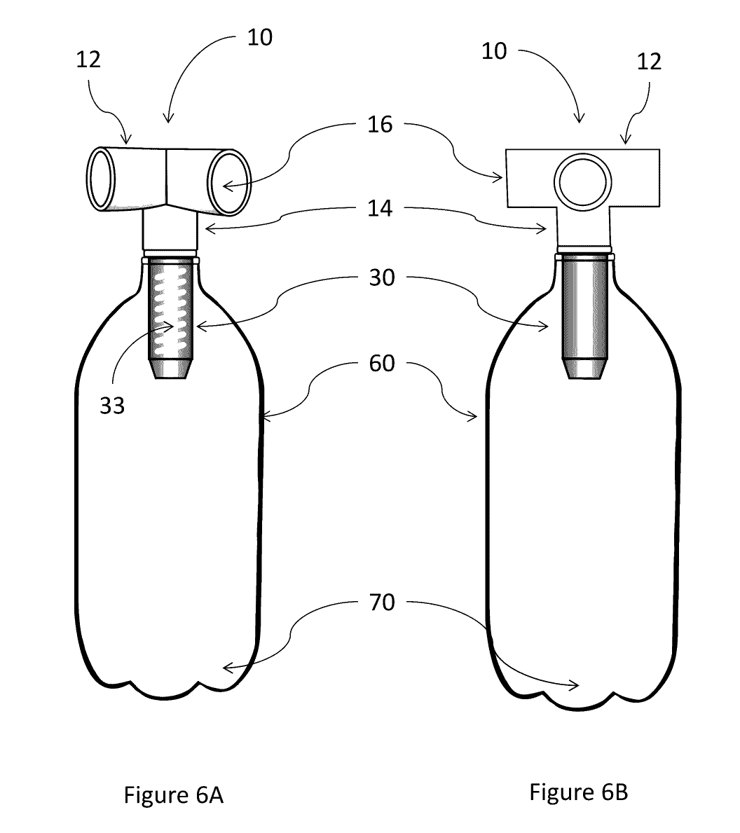

In some embodiments, bottom channel 14 may include internal threading configured to engage with external threading on at least one container opening (e.g., a weldspout 50 (see FIG. 5), or a screw top on a bottle 60 (see FIG. 6)). For example, in certain embodiments, the internal threading of bottom channel 14 may engage with threading located on a weldspout 50 of a plastic bag, while in other embodiments the internal threading may engage with external threading located on a screw top of a plastic bottle 60 (e.g., a soda bottle). In another embodiment, bottom channel 14 does not include threading, but may instead be configured to snap onto, or be otherwise fastened to, the at least one container opening. Other attachment mechanisms are contemplated.

In some embodiments, the apparatus of the present invention may include a funnel portion 30 having an elongated shaft 32 separating an open proximal end 34 and an open distal end 36. In certain embodiments, open proximal end 34 is configured to releasably fit within, or be otherwise functionally connected to, the bottom channel 14 of trap body 10 such that the funnel portion 30 is in fluid communication with the top and bottom flow paths 20. That is, in some embodiments, it is contemplated that the funnel portion 30 is a separate component from trap body 10, in which a proximal end 34 of the funnel portion 30 may be inserted into the trap body 10 through the trap body's bottom channel 14, while the distal end 36, as well as the majority of the elongated shaft 32, extend out from the bottom channel 14. When the insect trap is assembled, funnel portion 30 may be inserted into an opening of a container and trap body 10, which is configured to connect to the container opening, and will be arranged over the container opening and funnel portion 30, thereby securing funnel portion 30 to the container as well as trap body 10. In some embodiments, the funnel portion 30 may have a fully rigid construction, while in other embodiments the construction may be partially or fully flexible, e.g., to accommodate various container shapes and/or sizes.

In some embodiments, the funnel portion 30 includes a lip 38 that surrounds an edge of the funnel portion's open proximal end 34. Lip 38 may serve as a stop that prevents the funnel portion 30 from falling into a container. In some embodiments, lip 38 extends away from the edge of the funnel portion 30 only to the extent necessary to prevent the funnel portion 30 from falling into the container. In some embodiments, it is contemplated that lip 38 aligns with a top surface of the container opening (e.g., lip 38 does not extend out further than an outer surface of the container opening). In this way, lip 38 prevents the funnel portion 30 from falling into the container, but lip 38 does not prevent the bottom channel 14 from engaging and connecting with the container opening. Other means of fastening funnel portion 30 to the bottom channel 14 are also contemplated, such as by use of a fastening means, for example.

It is contemplated that funnel portion 30 may be any desired length and have any desired diameter suitable to carry out the various embodiments of the present invention.

As mentioned above, in some embodiments, the proximal and distal ends 34,36 of funnel portion 30 may be open. In this way, a flow path may be created between the open distal end 36 through the open proximal end 34 and into the flow paths 20 formed by the trap body's top and bottom channels 12,14. In preferred embodiments, the openings at the proximal and distal ends 34,36 are sufficiently large to allow an insect to enter the funnel portion 30.

In preferred embodiments, the funnel portion's elongated shaft 32 may include a plurality of apertures or vents 33. In preferred embodiments, the apertures 33 are configured to facilitate the flow of air (and, therefore, the bait scent) through the funnel portion 30. In some embodiments, the apertures 33 may be large enough for insects to pass through, but it is contemplated that this is not the aperture's primary purpose. For example, in other embodiments, apertures 33 are not large enough for insects to pass through and merely facilitate the flow of air through funnel portion 30. In some embodiments, the plurality of apertures 33 may be provided in place of an opening at the distal end 36. In such embodiments, the plurality of apertures 33 may function as openings for both insects to pass through and for the scent of the bait to flow through.

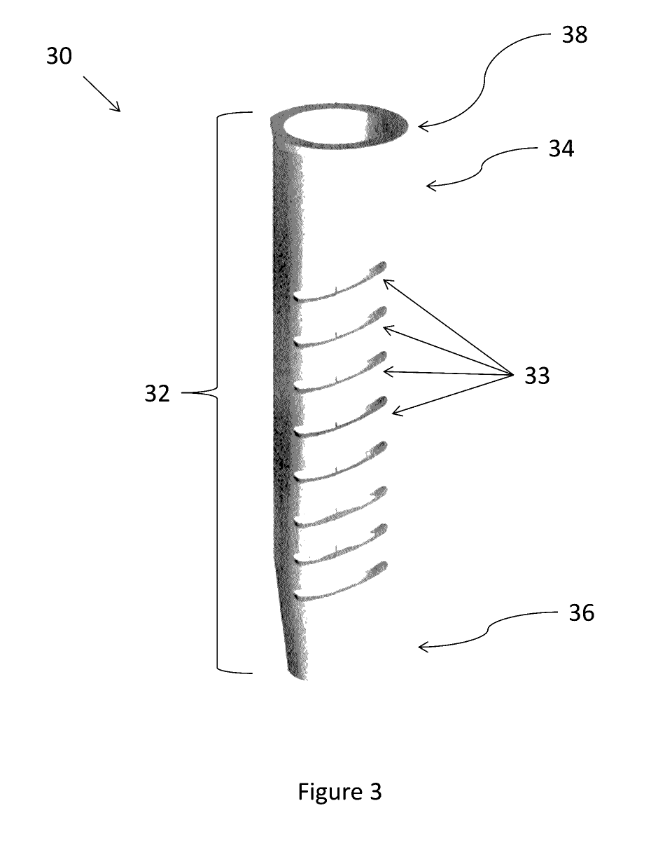

In some embodiments of the present invention, the funnel portion's distal end 36 may be tapered in a direction extending from the elongated shaft 32 to the opening at the funnel portion's distal end 36 as shown in, for example, FIG. 3. That is, in this embodiment, the diameter of the distal end 36 at the opening is narrower than the diameter of the elongated shaft 32 at, for example, apertures 33.

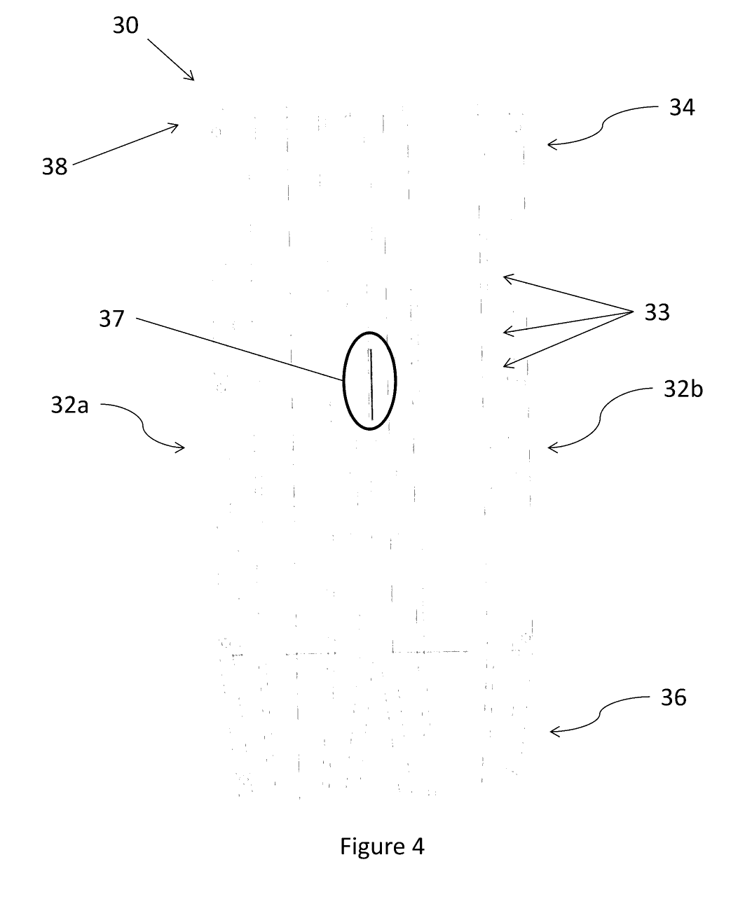

In some embodiments, funnel portion 30 may be formed in two or more parts or halves, such as first half 32a, and second half 32b as illustrated in, for example, FIG. 4. For example, in some embodiments, the funnel portion 30 may be split in half lengthwise such as, for example, along a longitudinal axis. In some embodiments, the funnel portion's first part 32a and second part 32b may be joined together by at least one hinge 37. In some embodiments, hinge 37 may be a living hinge, although other types of hinges are contemplated. Thus, in some embodiments, funnel portion 30 may have an open configuration, in which first part 32a and second part 32b may be open and arranged adjacent to each other on one side (see, e.g., FIG. 4), or a closed configuration, in which first part 32a and second part 32b may be closed and arranged face to face, thereby forming an enclosure (see, e.g., FIG. 3). In preferred embodiments, funnel portion 30 may have a cylindrical shape when in the closed configuration, although other shapes are possible. In some embodiments, funnel portion 30 may include at least one hinge 37, while, in other embodiments, funnel portion 30 may include two or more (e.g., a plurality of) hinges 37. In some embodiments, it is contemplated that funnel portion 30 is not formed in two pieces, but is instead formed as one integral piece.

In the embodiments where funnel portion 30 has one hinge 37 (e.g., a living hinge), hinge 37 may extend along a small portion (e.g., between 15% and 50%) of the funnel portion's longitudinal axis as shown in, for example, FIG. 4. In this embodiment, hinge 37 may be located at an approximate middle section of the funnel portion as shown in FIG. 4, although other locations are contemplated. For example, funnel portion 30 may have a top section (e.g., including proximal end 34), a middle section, and a bottom section (e.g., including distal end 36), and hinge 37 may be located in any one of these sections such as, for example, the middle section.

In other embodiments, hinge 37 may extend along a large portion (e.g., between 51% and 95%) of the funnel portion's longitudinal axis (not shown in FIG. 4). That is, hinge 37 may extend substantially the entire length of funnel portion 30, such as, for example, from proximal end 34 to the top of the tapered part at distal end 36. For example, hinge 37 may extend from the top section, through the middle section, and into at least a portion of the bottom section (e.g., stopping at the tapered part). Or, in another example, hinge 37 may extend from at least a portion of the top section, through the middle section, and into at least a portion of the bottom section. Other arrangements are possible.

In some embodiments, funnel portion 30 may be approximately 3-6 inches long or, preferably, 4-5 inches long. In some embodiments, the internal diameter of funnel portion 30 may be approximately 0.4-0.6 inches or, preferably, approximately 0.5 inches. The external diameter of funnel portion 30 may be approximately 0.7-0.9 inches or, preferably, approximately 0.8 inches.

In addition, certain embodiments of the present invention may include at least one container configured to hold bait for insects. In preferred embodiments, the at least one container has at least one container opening configured to accept the funnel portion 30 therethrough and is further configured to engage with the bottom channel 14 such that the at least one container is in fluid communication with the top and bottom flow paths 20. That is, distal end 36 as well as a portion of elongated shaft 32 that is not inserted into, or otherwise operatively connected to, bottom channel 14 of trap body 10, is inserted into the container through the container opening. The diameter of bottom channel 14 is large enough to accommodate the funnel portion's proximal end 34 as well as the container's opening. In this way, top channel(s) 12, bottom channel 14 and funnel portion 30 establish a continuous flow path between the internal contents of the at least one container and the outside environment. In some embodiments, the diameter of the bottom channel 14 may be sized to match the size of the container's opening such that the bottom channel 14 and the container opening may be functionally and/or fluidly connected, for example, by use of a fastening means. In accordance with the various embodiments, the continuous flow path ensures that the scent of the bait contained within the container is sufficiently dispersed throughout the surrounding environment, and the arrangement of the top channel(s) 12 and bottom channel 14 is configured to facilitate and aid the distribution of the scent around trap body 10.

In certain embodiments, the at least one container is a bag or a bottle (e.g., bottle 60 (see FIG. 6)). For example, in some embodiments, the container may be a plastic bag having, for example, a weldspout 50 while in other embodiments the container may be a plastic soda bottle 60. Containers made of materials other than plastic, (e.g., paper, metal or glass) are also contemplated.

Preferably, the at least one container is made of a transparent (e.g., clear or translucent) material. In this way, insects trapped within the container may be motivated to move horizontally (e.g., towards the light) rather than vertically towards trap body 10, which effectively blocks light shining into the container from above.

In embodiments where the container is a plastic bag, the bag may include a weldspout 50 configured to connect with the bottom channel 14 of trap body 10, and further configured to accept the funnel portion 30 inserted therein. Weldspouts are well known in the industry. An example of a weldspout is manufactured by the company Menshen (e.g., Menshen GmbH & Co. KG, including Menshen Packaging USA Inc.). Weldspouts, such as weldspout 50, include a top portion 52 and an attachment portion 51. Attachment portion 51 is generally configured to be attached to a container, such as a bag or pouch as is well known in the art. The top portion 52 may be configured to engage with bottom channel 14 of trap body 10. For example, in certain embodiments, top portion 52 may be a screw top having external threading and configured to engage with internal threading in bottom channel 14. In embodiments where the container is a bottle, the bottle may include a screw top (similar to the screw top portion 52 of weldspout 50) configured to connect with the bottom channel 14 of trap body 10, and further configured to accept the funnel portion 30 inserted therein.

Reference is now made to FIGS. 5A-5D, which illustrate a trap body 10 attached to a weldspout 50 according to aspects of certain embodiments of the present invention. FIG. 5C, which is a cross-section view through section A-A of FIG. 5B, depicts a trap body/weldspout assembly, in which the internal threading of bottom channel 14 is engaged with external threading located on top portion 52 of weldspout 50. In this way, trap body 10 may be easily screwed on or off of weldspout 50. FIG. 5D illustrates a magnified view of a portion of the connection between top portion 52 and bottom channel 14, where, in certain embodiments, x is approximately 0.4-0.6 inches (preferably, approximately 0.5-0.6 inches), and Θ is approximately 40-50 degrees (preferably, approximately 44-47 degrees).

According to certain aspects of the invention, the screw top on the weldspout 50 or bottle 60 may be an industry standard screw top, such as the screw top described in, for example, U.S. Pat. No. 4,007,848, issued Feb. 15, 1977 and entitled “ANTI-MISSILING BOTTLE STRUCTURE”, which is incorporated herein in its entirety. For example, the screw top may be the industry standard PCO 1881, standardized by, for example, the International Society of Beverage Technologies (www.bevtech.org). However, other screw tops are also contemplated.

In yet another embodiment of the present invention the at least one container, which, in some embodiments, may be configured to hold bait and/or trapped flies, may be situated or arranged within a second container, and the second container includes a plurality of holes (e.g., apertures or openings). For example, in one embodiment, the container is a bag that is placed into a cup having a plurality of holes. Light enters the cup through the holes thus keeping the insects contained within the bag moving horizontally (e.g., towards the holes) rather than vertically (e.g., towards an exit from the trap).

The apparatus for trapping insects according to aspects of certain embodiments of the present invention may be assembled by first placing bait 70 (see FIG. 6) for one or more insects into a container having a container opening. In some embodiments, the container may be a bag having a weldspout 50 or a bottle 60 having a screw top opening (e.g., a soda bottle). Next, funnel portion 30 is inserted into the container (e.g., bottle 60 in FIG. 6) through the container opening. The funnel portion's distal end 36 is first inserted through the container opening followed by elongated shaft 32 and at least a portion of proximal end 34. Proximal end 34 includes lip 38, which is configured to rest on a top edge of the container opening, and which acts as a stop and that prevents funnel portion 30 from falling into the container. Bottom channel 14 of trap body 10 is then slipped over the container opening as well as lip 38. As discussed above, in some embodiments bottom channel 14 may include internal threading configured to engage with external threading on weldspout 50 or the screw top on bottle 60. In these embodiments, trap body 10 is screwed onto the container opening via bottom channel 14 thereby securing trap body 10, as well as funnel portion 30, onto the container and completing the assembly of the insect trap. The scent within the container may then waft through funnel portion 30 (via, e.g., apertures 33 (FIGS. 3, 4 and 6)), though bottom flow path 20c of bottom channel 14, and into top flow path(s) 20a,20b of top channel(s) 12a,12b where it is mixed with air flowing through top channel(s) 12a,12b thereby dispersing the scent of the bait to permeate the environment.

In some embodiments, the insect trap apparatus may be placed upright on a flat surface (e.g., the ground, a table top, etc.), or may be hung by attaching a string, rope or chain to, for example, a portion of the container and hanging the apparatus from an elevated place (e.g., a tree, a doorway, a fencepost, etc.). In other embodiments, the container may be placed upside down such that the insect trap apparatus rests on trap body 10.

In some embodiments, it is contemplated that funnel portion 30 may not be necessary and may not be used in connection with the apparatus for trapping insects.

Reference is now made to FIGS. 6A and 6B, which are illustrations of different perspectives of a trap body 10 and funnel portion 30 attached to a container 60 according to aspects of certain embodiments of the present invention. FIGS. 6A and 6B depict a trap body 10 having a substantially “+” shape according to aspects of certain embodiments of the present invention, although other configurations are contemplated, such as, for example, a ‘T’ shape as discussed herein. FIG. 6A depicts apertures 33 of funnel portion 30, and it is contemplated that the trap assembly in FIG. 6B has been turned or rotated such that apertures 33 are hidden from view. As may be seen in FIGS. 6A and 6B, bait 70 may be placed within bottle 60 prior to assembling the trap assembly (e.g., trap body 10 with funnel portion 30) on the top of bottle 60.

In some embodiments, multiple top channels 12 may be provided which do not cross each other but instead each individually forms a ‘T’ shape with the bottom channel, e.g., as one ‘T’ above another ‘T’. In some embodiments, a top channel may be configured to be pivoted or otherwise be angled with respect to bottom channel 14 such that the top channel 12 and bottom channel 14 are not perpendicular to each other. Such embodiments may enable maximizing air flow through the top channel by being directionally adjusted to conform or align with a particular wind/air flow direction, e.g., at the location of the trap.

In an alternative embodiment, the apparatus for trapping insects may be modular. For example, trap body 10 may be configured to connect with one or more additional trap bodies. In certain embodiments, a first trap body 10 may connect to a second trap body via a first top channel 12a that is configured to engage (e.g., connect) with a second top channel 12a. In some embodiments, at least one opening 16 of a first top channel 12 on a first trap body 10 may be configured to connect with at least one opening 16 of a second top channel 12a of another trap body 10, which may allow for at least two trap bodies to be connected to each other. In another embodiment, at least two openings 16 of a first top channel 12 on a first trap body 10 may be configured to connect with at least one opening 16 on at least two additional trap bodies 10, which may allow for at least three trap bodies to be connected to each other, but may also allow for two or more (e.g., a plurality) of trap bodies to be connected. In yet another alternative embodiment in which a first trap body 10 has at least two top channels 12a,12b, each opening 16 of each top channel 12a,12b may be configured to connection with any other opening 16 of another trap body 10.

In certain embodiments, the apparatus for trapping insects may be made of several pieces such as, for example, a funnel portion 30 and a separate trap body 10. In an alternative embodiment, funnel portion 30 and trap body 10 may be made as one integrated piece. For example, funnel portion 30 may be attached to bottom channel 14 within flow channel 20c, leaving sufficient space (e.g., a gap) between an outer perimeter of funnel portion 30 and an inner perimeter of bottom channel 14 to accept the container opening. Other configurations are also contemplated.

It will be evident to those skilled in the art that the invention is not limited to the details of the foregoing illustrative embodiments and that the present invention may be embodied in other specific forms without departing from the spirit or essential attributes thereof.

The embodiments presented herein are, therefore, to be considered in all respects as illustrative and not restrictive of the scope of the invention, and the skilled artisan will appreciate the appropriate equivalents thereto, which are to be considered as part of this invention.

1. An apparatus for trapping insects comprising:
a trap body comprising:
at least one top channel having at least two opposed openings, said at least one top channel forming a top flow path through which air may freely flow; and
a bottom channel arranged transverse to the top channel and having a first opening in fluid communication with the top flow path and a second opening opposing the first opening, said bottom channel forming a bottom flow path through which air may freely flow;
wherein the trap body is configured to be operatively connected to at least one container, the at least one container configured to hold a bait for insects, and having at least one container opening configured to engage with the bottom channel such that the at least one container is in fluid communication with the top and bottom flow paths.

2. The apparatus according to claim 1, further comprising a funnel portion having an elongated shaft separating an open proximal end and an open distal end, the open proximal end configured to releasably fit within the bottom channel such that the funnel portion is in fluid communication with the top and bottom flow paths, the elongated shaft having a plurality of apertures.

3. The apparatus according to claim 1, wherein the at least one container is a bag or a bottle.

4. The apparatus according to claim 1, wherein the at least one container is a bag having a weldspout configured to connect with the bottom channel.

5. The apparatus according to claim 1, wherein the second opening of the bottom channel comprises internal threading configured engage with external threading on the at least one container opening.

6. The apparatus according to claim 1, wherein the second opening of the bottom channel is configured to snap onto the at least one container opening.

7. The apparatus according to claim 1, wherein the trap body comprises at least two top channels, each top channel having at least two opposed openings.

8. The apparatus according to claim 7, wherein a first top channel of the at least two top channels is arranged transverse to a second top channel, thereby forming a first top flow path intersecting a second top flow path.

9. The apparatus according to claim 2, wherein the funnel portion is formed as two halves which align to form the funnel portion.

10. The apparatus according to claim 9, wherein the two halves of the funnel portion are connected via a hinge.

11. The apparatus according to claim 9, wherein the hinge is a living hinge.

12. The apparatus according to claim 2, wherein the distal end of the funnel portion is tapered in a direction extending from the elongated shaft to the open distal end.

13. The apparatus according to claim 2, wherein a lip surrounds an edge of the open proximal end of the funnel portion, the lip configured to sit on a top surface of the at least one container opening, thereby preventing the funnel portion from falling into the container.

14. The apparatus according to claim 1, wherein the at least one container is a bag situated within a second container, said second container having a plurality of holes.

15. The apparatus according to claim 1, wherein each of the at least two opposed openings of the at least one top channel is vertically arranged transverse to a longitudinal axis of the at least one top channel.

16. The apparatus according to claim 1, wherein a longitudinal axis of the at least one top channel is arranged transverse to a longitudinal axis of the bottom channel.

17. The apparatus according to claim 1, wherein the at least two opposed openings of the at least one top channel diametrically or substantially oppose each other.
